(19) United States
(12) Patent Application Publication
(10) Pub. No.: US 2017/0076640 A1
(43) Pub. Date: Mar. 16, 2017

(54) HEAT TRANSFER IMAGE/FLAG LABEL

(71) Applicant: Avery Dennison Retail Information Services LLC, Mentor, OH (US)

(72) Inventors: Robin E. Sonnenschein, London (GB); Lynsey Scott, Chriswick (GB)

(21) Appl. No.: 14/851,123

(22) Filed: Sep. 11, 2015

(51) Int. Cl. G09F 3/02; B41M 5/26

(52) U.S. Cl. CPC G09F 3/02; B41M 5/26; G09F 2003/0211; G09F 2003/0208; G09F 2003/0282

(57) ABSTRACT

A unique heat transfer and flag label for use on specific merchandising articles and/or for a specific event is disclosed. The heat transfer can be used to promote an event, a team, etc. Typically, the heat transfer is applied to an article of clothing, such as a shirt, a hat, shorts, or other garments, and would typically be a sports court or field. The flag label can have a clear background so that the garment can be seen underneath and only the lines of the sports court or field would be visible, or the background could be the color of the field or court and resemble some of the team backgrounds

### BACKGROUND

The present invention relates generally to a heat transfer image/flag label. The present subject matter is especially suitable for labeling garments. In accordance with embodiments of the present subject matter, heat transfer images/flag labels for clothing and other articles are provided. Accordingly, the present specification makes specific reference thereto. However, it is to be appreciated that aspects of the present inventive subject matter are also equally amenable to other like applications.

Printed flag labels are well-known and commonly used on garments, such as jeans or shirt pockets, to allow brand owners to display their brand. The flag label disclosed herein incorporates a branded flag label with a heat transfer background.

Specifically, the present invention discloses a unique heat transfer and flag label for use on specific merchandising articles and/or for a specific event. The heat transfer can be used to promote an event, a team, etc. Typically, the heat transfer is applied to an article of clothing, such as a shirt, a hat, shorts, or other garments. The heat transfer would typically be a sports court or field. The label can have a clear background so that the garment can be seen underneath and only the lines of the sports court or field would be visible, or the background could be the color of the field or court and resemble some of the team backgrounds.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a unique heat transfer and flag label for use on specific merchandising articles and/or for a specific event. The flag label comprises a heat transfer background that displays a particular sports court or field. In one embodiment, the flag label also displays the particular brand of the garment.

In a preferred embodiment, the heat transfer is applied to an article of clothing, such as a shirt, a hat, shorts, or other garments. The heat transfer would typically be a sports court or field. The label either comprises a clear background so that the garment can be seen underneath and only the lines of the sports court or field would be visible, or the background comprises the color of the field or court and resembles some of the team backgrounds.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 illustrates a perspective view of an exemplary heat transfer image/flag label in accordance with the disclosed architecture;

FIG. 2 illustrates a perspective view of a tennis court heat transfer image/flag label in accordance with the disclosed architecture;

FIG. 3 illustrates a perspective view of a soccer field heat transfer image/flag label in accordance with the disclosed architecture;

FIG. 4 illustrates a perspective view of a basketball court heat transfer image/flag label in accordance with the disclosed architecture; and

FIG. 5 illustrates a perspective view of a football field heat transfer image/flag label in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

A unique heat transfer and flag label for use on specific merchandising articles and/or for a specific event is disclosed. The heat transfer can be used to promote an event, a team, etc. Typically, the heat transfer is applied to an article of clothing, such as a shirt, a hat, shorts, or other garments, and the heat transfer would typically depict a sports court or field. The flag label can have a clear background such that the garment can be seen underneath and only the lines of the sports court or field would be visible, or the background can be the color of the field or court and resemble some of the team backgrounds.

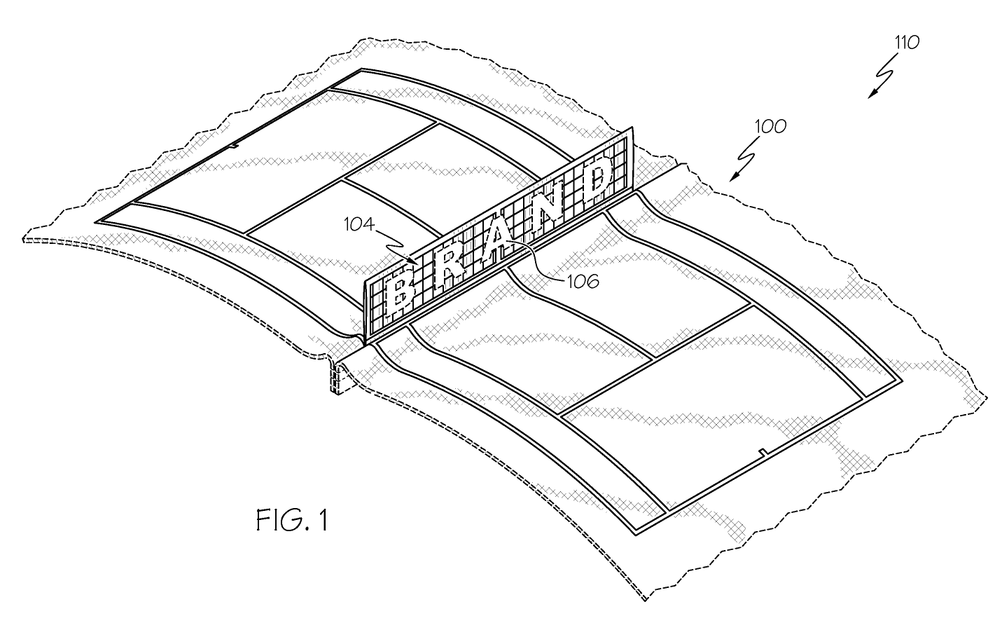

Referring initially to the drawings, FIG. 1 illustrates a heat transfer image/flag label 100. The heat transfer image/flag label 100 generally comprises a flag label 102 and one or more printed heat transfer images 104 configured to define one or more graphics and/or text. The heat transfer image/flag label 100 would be applied to specific merchandising apparel and/or to promote a specific event. The unique heat transfer images 104 may be formed by any suitable method for forming heat transfers as is known in the art.

The unique heat transfer images 104 further comprises printed matter 106. The printed matter 106 would be visually recognizable information incorporating text, pictures, and numbers, which are associated with a specific sport or event. Any suitable printed material can be incorporated into the printed matter 106 of the heat transfer image 104, as is known in the art as long as it pertains to the specific event or sport.

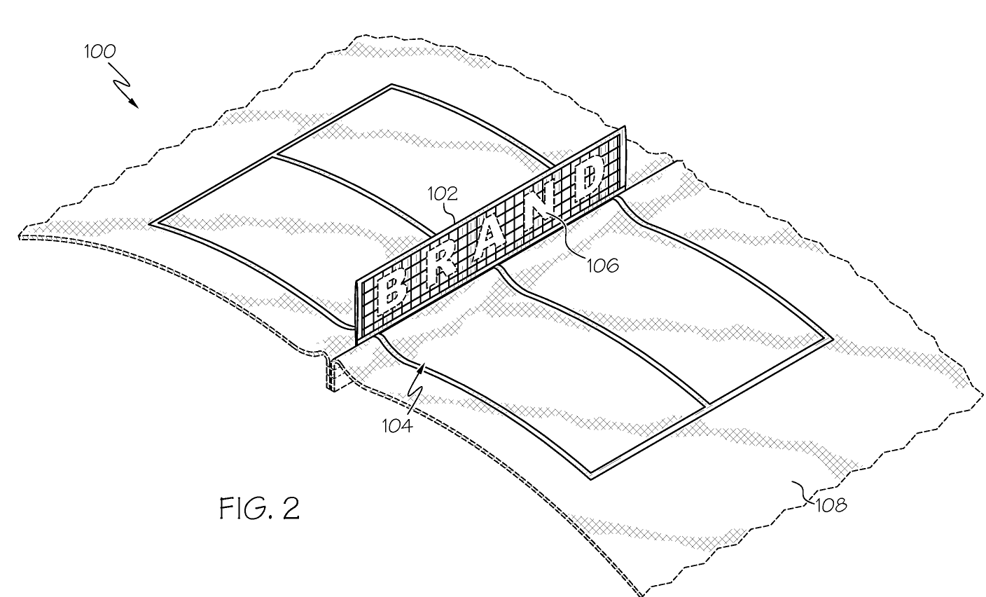

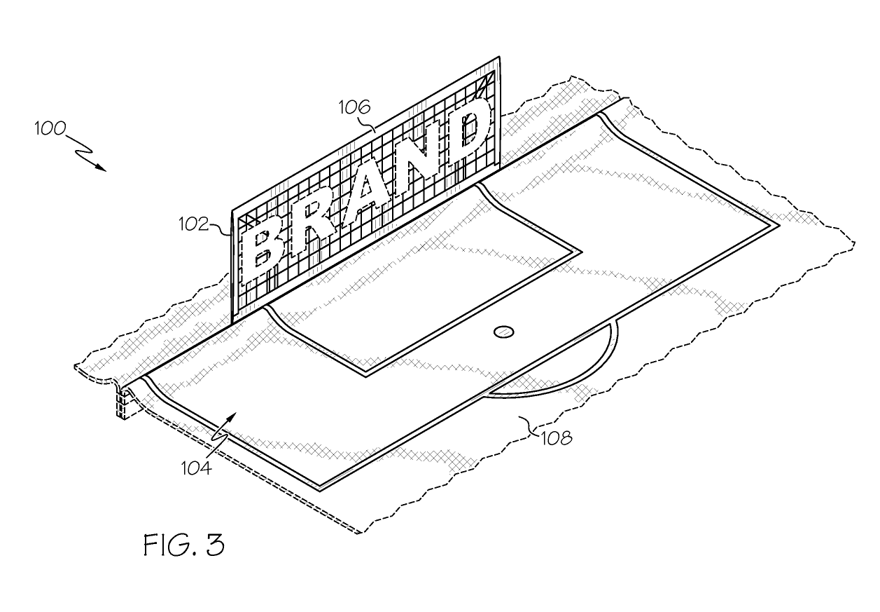

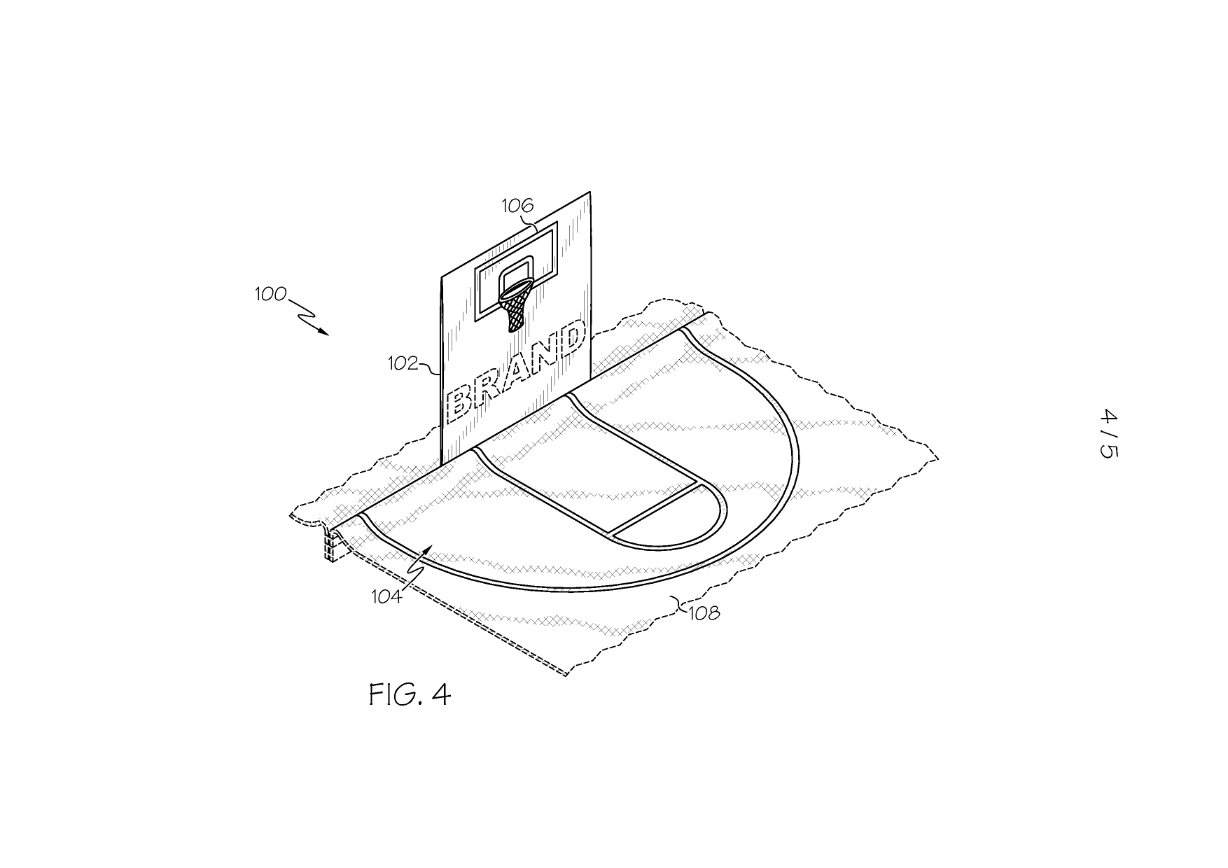

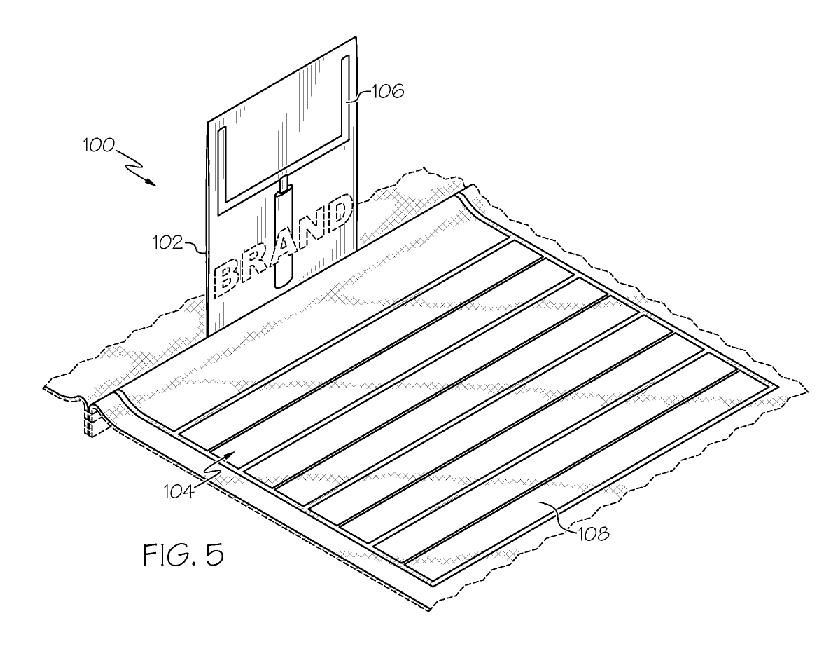

Typically, as shown in FIGS. 2-5, the printed matter 106 comprises a particular sport court or field, such as a tennis court (see FIG. 2), a badminton court, a volleyball court, a table tennis court, a football field (see FIG. 5), a soccer field (see FIG. 3), or a basketball court (see FIG. 4), etc. The particular sport court or field would be applied as a heat transfer image 104 and the flag label 102 would comprise not only a particular component of the field or court, but also a brand name for identification purposes. Further, the flag label 102 can have a clear background so that the garment can be seen underneath and only the lines of the sports court or field would be visible, or the background could be the color of the field or court and resemble some of the team backgrounds.

The particular component of the field or court on the flag label 102 could be a tennis net (see FIG. 2), a soccer goal (see FIG. 3), a basketball goal (see FIG. 4), or a football field goal (see FIG. 5). Furthermore, if the heat transfer image/flag label 100 is used to identify a specific event, a sponsor's image or logo for the specific event can also be printed on the heat transfer image 104, as well as other identifying information for the sponsor, such as unique colors or slogans that are associated with the sponsor, etc.

Furthermore, the printed matter 106 would be printed with any suitable ink as is known in the art. For example, the printed matter 106 can be printed with ultraviolet-curable inks to provide a printed matter 106 that includes optically readable information, has excellent durability against wind, rain, and light, and can be produced more simply and at low cost. The ultraviolet-curable inks can be any type as long as the ink can be cured by being irradiated with ultraviolet radiation. Other suitable inks can be used for the printed matter 106 as is known in the art, as long as the inks provide visually recognizable information and durability against adverse conditions. Furthermore, the images are typically printed with a digital printer, or offset presses, such as Indigo® available from HP of Palo Alto, Calif. Images can also be produced using conventional flexographic or gravure printing equipment.

Additionally, the heat transfer image 104 is applied to a base material 108. The base material 108 is typically a non-woven fabric material, but can be any suitable material as is known in the art. The base material 108 is typically produced using routine methods known in the art. Further, the base material 108 would typically be part of (incorporated into) a clothing article 110, such as a shirt, shorts, cap, sweatshirt, jersey, etc., or any other suitable clothing article 110 as is known in the art. The heat transfer image 104 is applied to the clothing article 110 via any suitable method as is known in the art for applying heat transfers. The heat transfer image 104 would be applied to the inside or the outside of the clothing article 110, or even on a tag of the clothing article 110 depending on the wants and/or needs of the manufacturer or user.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A heat transfer image/flag label for use on apparel, comprising:
a flag label; and
at least one printed heat transfer image configured to define one or more graphics and/or text on the flag label.

2. The heat transfer image/flag label of claim 1, wherein the at least one printed heat transfer image comprises a sports court or field.

3. The heat transfer image/flag label of claim 2, wherein the sports court or field is comprised of at least one of a tennis court, a football field, a soccer field, a basketball court, a badminton court, a volleyball court, or a table tennis court.

4. The heat transfer image/flag label of claim 3, wherein the flag label further comprises a component of the sports court or field.

5. The heat transfer image/flag label of claim 4, wherein the component comprises at least one of a tennis net, a soccer goal, a basketball goal, or a football field goal.

6. The heat transfer image/flag label of claim 5, wherein the flag label further comprises a brand name.

7. The heat transfer image/flag label of claim 1, wherein the at least one printed heat transfer image is printed with ultraviolet-curable inks to provide printed matter that includes optically readable information.

8. The heat transfer image/flag label of claim 1, wherein the at least one printed heat transfer image is applied to a base material.

9. The heat transfer image/flag label of claim 8, wherein the base material is typically a non-woven fabric material.

10. The heat transfer image/flag label of claim 9, wherein the base material is incorporated into a clothing article.

11. The heat transfer image/flag label of claim 10, wherein the clothing article comprises at least one of a shirt, shorts, cap, sweatshirt, or jersey.

12. A heat transfer image/flag label for use on apparel, comprising:
a flag label; and
at least one printed heat transfer image configured to define a sports court or field on the flag label; and
wherein the sports court or field is comprised of at least one of a tennis court, a football field, a soccer field, a basketball court, a badminton court, a volleyball court, or a table tennis court.

13. The heat transfer image/flag label of claim 12, wherein the flag label further comprises a component of the sports court or field.

14. The heat transfer image/flag label of claim 13, wherein the component comprises at least one of a tennis net, a soccer goal, a basketball goal, or a football field goal.

15. The heat transfer image/flag label of claim 14, wherein the flag label further comprises a brand name.

16. The heat transfer image/flag label of claim 12, wherein the at least one printed heat transfer image is applied to a base material.

17. The heat transfer image/flag label of claim 16, wherein the base material is typically a non-woven fabric material.

18. The heat transfer image/flag label of claim 17, wherein the base material is incorporated into a clothing article.

19. The heat transfer image/flag label of claim 18, wherein the clothing article comprises at least one of a shirt, shorts, cap, sweatshirt, or jersey.

20. A heat transfer image/flag label for use on apparel, comprising:
a flag label comprising a brand name; and
at least one printed heat transfer image configured to define a sports court or field and a component of the sports court or field on the flag label; and
wherein the sports court or field is comprised of at least one of a tennis court, a football field, a soccer field, a basketball court, a badminton court, a volleyball court, or a table tennis court; and
wherein the component of the sports court or field comprises at least one of a tennis net, a soccer goal, a basketball goal, or a football field goal; and
wherein the at least one printed heat transfer image is applied to a non-woven base material which is incorporated into a clothing article.
